(19) United States
(12) Patent Application Publication
(10) Pub. No.: US 2007/0216839 A1
(43) Pub. Date: Sep. 20, 2007

(54) TRANSFLECTIVE LIQUID CRYSTAL DISPLAY DEVICE

(75) Inventor: Stephen J. Battersby, Haywards Heath (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,446

(22) PCT Filed: May 25, 2005
(86) PCT No.: PCT/IB05/51711

§ 371 Date: Nov. 21, 2006

(30) Foreign Application Priority Data
May 28, 2004 (GB) 0411968.1

(51) Int. Cl. G02F 1/1343

(52) U.S. Cl. 349/139; 349/187

(57) ABSTRACT

A transflective display device has a well (30) formed in an insulating layer (20) for defining a dual-gap arrangement. At least one side wall (72) of the well is substantially perpendicular to the plane of the substrate and at least one side wall (70) is sloped away from the perpendicular to the plane of the substrate. In this way, some of the length of the well side wall is vertical, so that no pixel aperture is lost, and another part of the length of the side wall of the well is sloped so that good coverage can be obtained over that sloped side wall.

The present invention relates to a liquid crystal display, and more particularly, to a transflective liquid crystal display and method of fabricating the same.

Liquid Crystal Display (LCD) devices are relatively thin and require low power for operation, when compared to CRT display devices. LCD devices are gradually replacing CRT display devices in a variety of technical fields.

Until recently, there have been two basic types of liquid crystal display; transmissive displays and reflective displays, the main difference being whether an internal or external light source is used.

A transmissive display has a liquid crystal display panel that does not itself emit light, and has a backlight as a light source. The backlight is disposed at the rear or one side of the panel, and a light guide directs the light across the display area. The liquid crystal panel controls the amount of the light which passes through the liquid crystal panel, in order to implement an image display. The backlight of transmissive LCD displays typically consumes 50% or more of the total power consumption.

In order to reduce power consumption, reflective LCDs have been developed, primarily for portable applications. A reflective LCD is provided with a reflector formed on one of a pair of substrates. Thus, ambient light is reflected from the surface of the reflector. The performance of a reflective LCD is poor when there are low levels of ambient light.

To overcome the problems described above, so-called transflective displays have been developed, which combine a transmissive mode and a reflective mode in a single liquid crystal display device. A transflective liquid crystal display (LCD) device alternatively acts as a transmissive LCD device and a reflective LCD device. By using both internal and external light sources depending on the ambient conditions, it can be operated in all light conditions and has a low power consumption.

The ideal liquid crystal characteristics for a reflective display and for a transmissive display are not the same. If the liquid crystal cell is designed principally for use in the reflective mode, then the light transmission from the backlight in the transmissive mode will be poor, reducing image quality in the transmissive mode. It has therefore been proposed to provide the transflective liquid crystal display device with different liquid crystal cell gaps in the reflective portion of each pixel and in the transmissive portion of each pixel.

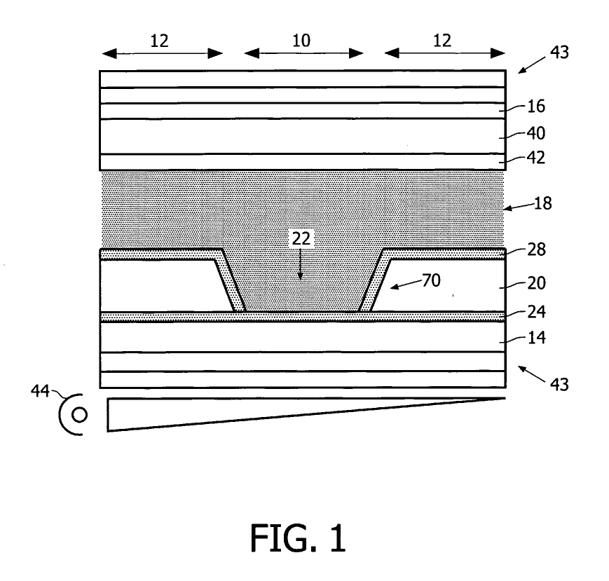

FIG. 1 is a schematic cross-sectional view of a known transflective LCD device having a transmissive portion and a reflective portion.

In FIG. 1, the transflective LCD device is divided into a transmissive portion 10 and a reflective portion 12, and includes lower and upper substrates 14 and 16. A liquid crystal layer 18 having optical anisotropy is interposed between the lower and upper substrates 14, 16.

The lower substrate 14 includes a transparent electrode 24 of transparent conductive material on its surface facing the upper substrate 16. A passivation layer 20 is provided over the transparent electrode 24. The passivation layer 20 is made of an organic polymer material and has a first transmitting hole 22 corresponding to the transmissive portion 10. The thickness of the polymer material may typically be approximately 2 μm, and is for example benzocyclobutane (BCB). Although not shown in FIG. 1, layer 20 will, in general, have a bumpy (non-flat) surface so that the reflective electrode 28 has a controlled diffuse scattering characteristic rather than a specular one. This layer is known as an in-cell diffuse reflector (IDR). The layer 20 may therefore, in practice, be made up of more than one layer (though one is also possible). For example, one layer might be approximately 2 μm thick to control the cell gap and a second, thinner layer, is then etched in a bumpy pattern to control the scattering.

A reflective electrode 28 is formed on the passivation layer 20. As shown in FIG. 1, the reflective electrode 28 corresponds to the reflective portion 12. The reflective electrode 28 extends down the side walls of the hole 22 in the passivation layer 20 to make electrical connection between the two electrodes 24,28. This avoids the need for other structures to be defined to make the electrical contact between the two electrodes. Although not shown in FIG. 1, a thin film transistor (TFT) is formed on the lower substrate 14 and electrically connected to both the transparent electrode 24 and the reflective electrode 28.

The upper substrate 16 includes a color filter layer 40 and a common electrode layer 42 formed on the surface of the color filter layer 40.

Retardation films and polarizers 43 are formed on the outer surfaces of the lower and upper substrates 14 and 16

An optical retardation of the liquid crystal layer 18 depends on refractive-index anisotropy and the thickness of the liquid crystal layer. Therefore, the liquid crystal layer 18 has different cell gaps in the transmissive portion 10 and in the reflective portion 12, giving rise to a so-called “dual gap” structure. The transmitting hole 22 of the passivation layer 20 allows the liquid crystal layer 18 of the transmissive portion 10 to be thicker than that of the reflective portion 12, thus allowing the optical properties of the two portions to be optimised independently, offering superior brightness and contrast ratio for the combined transflective pixel. The thickness of the liquid crystal layer 18 in the transmissive -portion 10 may be approximately twice that in the reflective portion 12.

The backlight is shown as 44.

As mentioned above, the pixels each also include a thin film transistor. This may have a top gate structure or a bottom gate structure. The top gate process has ITO for the source and drain of the TFT and is the first deposited layer, whereas in the bottom gate process, the first deposited layer is metal (for the gate) followed by another metal (for the source and drain) and the ITO is put down as a third layer.

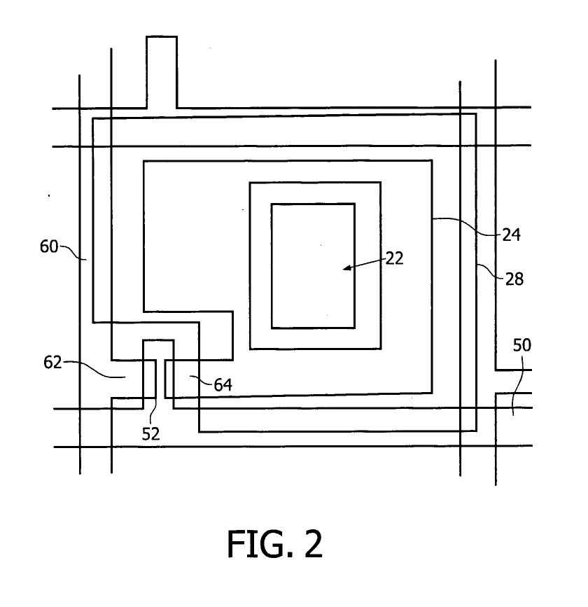

FIG. 2 shows in plan view a pixel of the transflective LCD device of FIG. 1, and assumes a top gate TFT structure. Each pixel includes a row gate line 50 having a TFT gate electrode 52 extending from the gate line. A column data line 60 defines a source electrode 62 which extends beneath the gate electrode 52.

A drain electrode 64 is formed spaced apart from the source electrode 62 from the same ITO layer, and this drain electrode 64 is formed as a part of the ITO pixel electrode 24. The pixel electrode 24 connects to the reflective metal electrode 28 down the opening in the reflective electrode 28, which typically has a rectangular shape.

The hole 22 in the passivation layer 20 has slanted side walls. These slanted side walls give an undesirable gradual change in cell thickness. However, the slanted side walls are required to avoid step coverage problems, as the reflective electrode 28 is required to extend over the side walls.

The sloped side walls give rise to a dead region, where the area occupied is contributing neither to the transmissive nor reflective output of the display. Where the reflective electrode extends over the side walls, this reflective electrode is not facing the display output direction, and does not therefore contribute to the optical output.

For large pixel pitches, this dead region is small compared to the area of either the reflective or transmissive electrodes. However, as the pitch decreases, the dead region becomes more significant, and indeed provides a limitation to the reduction in pixel size. For example for a polymer 2 μm thick, the dead region may be approximately 2 μm wide, so that 4 μm of pixel width is lost. Future generation displays are expected to have as many as 100 pixels per cm, giving a (triplet) pixel pitch of around 100 μm. With the corresponding pitch of 34 μm for each individual colour sub-pixel including the conductor lines, it is self-evident that the dead region becomes highly significant.

It would be desirable to provide vertical side walls for the well in the passivation layer, but this is incompatible with enabling step coverage over the well side walls.

According to the invention, there is provided a transflective display device, comprising a plurality of display pixels on a common substrate, each pixel comprising:

a reflective pixel region having a reflective electrode spaced from the substrate by an insulating layer; and

a transmissive pixel region having a transmissive electrode provided in a well formed in the insulating layer,

wherein the well formed in the insulating layer has at least one side wall substantially perpendicular to the plane of the substrate and at least one side wall which is sloped away from the perpendicular to the plane of the substrate.

In the device of the invention, a well is provided in an insulator to enable a dual gap arrangement to be defined. Some of the length of the well side wall is vertical, so that no pixel aperture is lost to the well, and another part of the length of the side wall of the well is sloped so that good coverage can be obtained over that sloped side wall.

The reflective electrode preferably extends over the at least one sloped side wall of the well to make electrical contact between the reflective electrode and the transmissive electrode.

The well is preferably rectangular, and three sides of the rectangle have side walls substantially perpendicular to the plane of the substrate and one, preferably shorter, side of the rectangle has a side wall which is sloped away from the perpendicular to the plane of the substrate.

The sloped side wall may be sloped such that the top and bottom of the slope are laterally offset by 1 μm -3 μm and the insulating layer may have a thickness of 1 μm -3 μm.

The device is preferably provided with a second substrate, and a liquid crystal layer is sandwiched between the substrate and the second substrate. The liquid crystal layer has regions of two different cell gaps within each pixel.

The invention also provided a method of manufacturing a transflective display device in which a plurality of display pixels are provided on a common substrate and each have a reflective pixel region having a reflective electrode spaced from the substrate by an insulating layer and a transmissive pixel region having a transmissive electrode provided in a well formed in the insulating layer, the method comprising:

patterning the insulating layer to define the well using an etching mask having a first abrupt edge region and a second diffraction grating edge region, wherein the well formed in the insulating layer has at least one side wall substantially perpendicular to the plane of the substrate defined by the abrupt edge region and at least one side wall which is sloped away from the perpendicular to the plane of the substrate defined by the diffraction grating edge region.

This method uses a diffraction grating in the etching mask to provide partial light exposure, preferably of a resist layer, which in turn gives rise to a slope in at least one part of the side wall of the insulating layer well. This enables a single etching process to define both vertical side walls and a sloped side wall for the insulating layer well.

The etching mask is preferably used to pattern a resist layer provided over the insulating layer, and the resist layer is subsequently etched to remove the exposed resist layer portions and the underlying insulating layer.

Examples of the invention will now be described in detail with reference to the accompanying drawings, in which:

FIG. 1 shows a known transflective LCD device in cross section;

FIG. 2 shows a pixel of a known transflective LCD device in plan view;

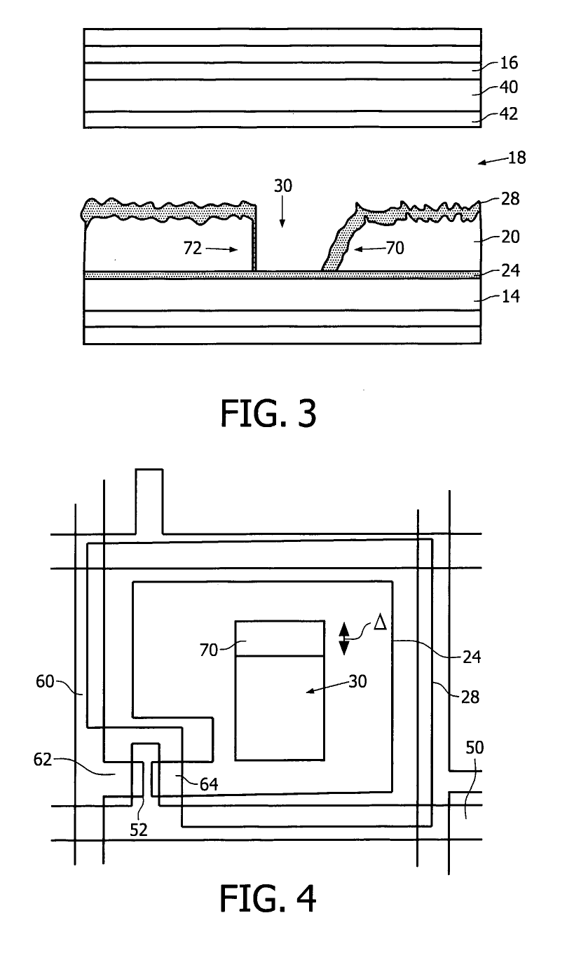

FIG. 3 shows a pixel of a transflective LCD device of the invention in cross section;

FIG. 4 shows a transflective LCD device of the invention in plan view; and

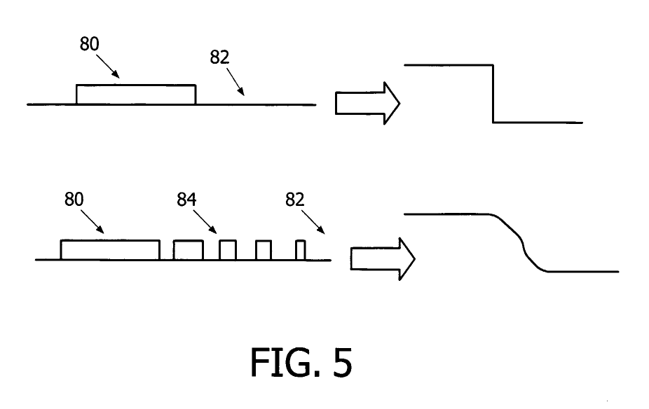

FIG. 5 shows an etching mask used in the method of the invention for manufacturing the transflective LCD device of the invention.

The transflective display device of the invention has an insulating layer with a well to define a dual-gap structure. The well has at least one vertical side wall and at least one sloped side wall. The use of vertical side walls enables a large pixel aperture to maintained, and the use of at least one sloped side wall allows good coverage and therefore electrical contact to be obtained over that sloped side wall.

FIG. 3 shows a pixel of a transflective LCD device of the invention in cross section. The same reference numerals are used as in FIG. 1.

FIG. 3 also shows schematically the rough surface of the passivation layer 20, and the duplication of this rough surface in the electrode 28. As mentioned above, this may be achieved using a multi-layer passivation layer 20.

As shown in FIG. 3, at least one side wall 72 of the opening 30 is vertical, namely perpendicular to the substrate 14, and at least one side wall 70 is sloped, to enable good coverage of an overlying layer. The reflective electrode 28 extends over the sloped side wall 70 of the well to make electrical contact between the reflective electrode 28 and the transmissive electrode 24. This avoids the need for other structures to make the electrical contact between the electrodes.

The transparent electrode 28 must cover all the region where the cell gap is small. The reflective electrode 28 is also shown in FIG. 3 as extending over the vertical side wall 72. This is the result of tolerance allowance, and there are no requirements for the continuity of the layer 28 down the vertical side wall 72.

As shown in FIG. 4, the well 30 is rectangular, and three sides of the rectangle have vertical side walls, and one of the shorter sides of the rectangle has a sloped side wall, over which the electrode 28 extends. In FIG. 4, the electrode 28 is shown as the dotted area, and the upper short side of the rectangular opening 30 has the sloped side wall 70 over which the electrode 28 extends.

The sloped side wall may be sloped such that the top and bottom of the slope are laterally offset by 1 μm-3 μm, shown as dimension A in FIG. 4. The insulating layer 20 may have a thickness of 1 μm-3 μm.

The mask used in the patterning of the passivation layer may be modified to provide the well structure of the invention. A single masking and etching stage can be used to create the well with different side wall slopes in the manner described below.

A slope can be created by forming a grating structure in an etching mask to tailor the illumination intensity during resist exposure, so that the resist, when developed has a sloped edge rather than a vertical one.

During manufacture, a positive resist layer is provided over a continuous layer of the passivation layer 20. FIG. 5 shows the mask design for controlling exposure of the resist layer. The top part of FIG. 5 shows an abrupt step in the mask between an opaque region 80 and a transparent region 82. The resist layer is fully exposed in the area corresponding to the transparent region 82. The bottom part of FIG. 5 shows a gradual step in the mask between an opaque region 80 and a transparent region 82, by defining a grating structure 84. The resist layer is fully exposed in the area corresponding to the transparent region 82, but there is a gradual decrease in exposure towards the area corresponding to the opaque region 80.

During etching, the exposed resist layer is removed at a much greater rate than the unexposed part of the resist layer. In the area corresponding to the grating structure 84, there is a progressive change in the rate of resist removal. In areas where there has been almost full exposure, the resist layer will be removed during etching, and the underlying passivation layer will also be partially etched. Thus, there will be a transfer of the exposure profile of the resist layer to the shape of the underlying passivation layer, and the sloped side wall can be formed with a single anisotropic mask and etch step.

The mask in the region 84 has a number of narrow lines and spaces to tailor the light intensity. The line/space ratio will vary from infinity (no spaces) at the edge of the opaque region to 0 (all space) at the edge of the transparent region, and this transition will occupy approximately 2 μm. The line widths and spaces need to be tailored to provide the required light diffraction pattern.

One example only of the invention has been described in detail above. However, the invention is applicable to any dual-gap transflective display in which good step coverage of any layer is required down a side wall of a passivation layer well. The advantages of the invention become more significant as the pixel pitch is reduced, either for small size displays with good resolution or for high resolution displays generally.

The invention has been described in detail above in an arrangement in which top gate TFTs are to be used in the pixel circuits. The invention may equally be applied to arrangements in which bottom gate TFTs are used.

Various modifications will be apparent to those skilled in the art.

1. A transflective display device, comprising a plurality of display pixels on a common substrate (14), each pixel comprising:
a reflective pixel region having a reflective electrode (28) spaced from the substrate by an insulating layer (20); and
a transmissive pixel region having a transmissive electrode (24) provided in a well (30) formed in the insulating layer (20),
wherein the well (30) formed in the insulating layer (20) has at least one side wall (72) substantially perpendicular to the plane of the substrate (14) and at least one side wall (70) which is sloped away from the perpendicular to the plane of the substrate.

2. A device as claimed in claim 1, wherein the reflective electrode (28) extends over the at least one sloped side wall (70) of the well to make electrical contact between the reflective electrode (28) and the transmissive electrode (24).

3. A device as claimed in claim 1, wherein the well (30) is rectangular.

4. A device as claimed in claim 3, wherein three sides of the rectangle have side walls substantially perpendicular to the plane of the substrate (14) and one side of the rectangle has a side wall (70) which is sloped away from the perpendicular to the plane of the substrate.

5. A device as claimed in claim 1, wherein the sloped side wall (70) is sloped such that the top and bottom of the slope are laterally offset (Δ) by 1 μm -3 μm.

6. A device as claimed in claim 1, wherein the insulating layer (20) has a thickness of 1 μm-3 μm.

7. A device as claimed in claim 1, further comprising a second substrate (16), and wherein a liquid crystal layer (18) is sandwiched between the substrate (14) and the second substrate (16), the liquid crystal layer having regions of two different cell gaps within each pixel.

8. A method of manufacturing a transflective display device in which a plurality of display pixels are provided on a common substrate and each have a reflective pixel region having a reflective electrode (28) spaced from the substrate by an insulating layer (20) and a transmissive pixel region having a transmissive electrode (24) provided in a well formed in the insulating layer, the method comprising:
patterning the insulating layer (20) to define the well using an etching mask having a first abrupt edge region (80) and a second diffraction grating edge region (84), wherein the well formed in the insulating layer has at least one side wall substantially perpendicular to the plane of the substrate defined by the abrupt edge region and at least one side wall which is sloped away from the perpendicular to the plane of the substrate defined by the diffraction grating edge region.

9. A method as claimed in claim 8, wherein the etching mask is used to pattern a resist layer provided over the insulating layer, and the resist layer is subsequently etched to remove the exposed resist layer portions and the underlying insulating layer.
